(19) United States
(12) Patent Application Publication
(10) Pub. No.: US 2021/0237609 A1
(43) Pub. Date: Aug. 5, 2021

(54) A METHOD TO PLAN THE OPTIMAL CONSTRUCTION QUANTITY AND SITE SELECTION SCHEME OF ELECTRIC VEHICLE CHARGING STATIONS

(71) Applicant: JIANGSU UNIVERSITY, Zhenjiang (CN)

(72) Inventors: WEI ZHANG, ZHENJIANG (CN); SHUPEI ZHANG, ZHENJIANG (CN); JIANGPENG LUO, ZHENJIANG (CN); GUOLIN WANG, ZHENJIANG (CN)

(21) Appl. No.: 16/975,057

(22) PCT Filed: Oct. 23, 2019
(86) PCT No.: PCT/CN2019/112635

§ 371 Date: Aug. 21, 2020

(30) Foreign Application Priority Data
Mar. 29, 2019 (CN) 201910249266.2

(51) Int. Cl. B60L 53/66; B60L 53/10; B60L 53/22; B60L 53/62

(52) U.S. Cl. CPC B60L 53/66; B60L 53/62; B60L 53/22; B60L 53/10

(57) ABSTRACT

The optimal construction quantity and site selection scheme of EV charging stations includes A parking points generated through simulation that acquires parking coordinates within city sub-regions based on relevant EV parameters and quantity q of charging stations to be constructed in the city. The target charging station is chosen and the selection model compiles constraint conditions for traveling balance and reserves site selection plans. Among site selection plans that satisfy constraint conditions, the user choses the construction quantity of charging stations with the lowest construction cost and determines the optimal site selection plan. The method to plan the optimal construction quantity and site selection scheme of EV charging stations as disclosed can effectively determine the optimal construction quantity and site selection plan for EV charging stations within a city.

### CROSS-REFERENCE TO RELATED PATENT APPLICATIONS

This application is a 371 National Stage application of International PCT Application No. PCT/CN2019/112635, filed Oct. 23, 2019, which claims the benefit of Chinese Patent Application No. 201910249266.2, filed Mar. 29, 2019, the entire contents of each of which are hereby incorporated by reference.

### TECHNICAL FIELD

The present invention belongs to the technical field of electric vehicle (EV) charging, particularly relating to a method to plan the optimal construction quantity and site selection scheme of EV charging stations.

### BACKGROUND ART

With the development of the global automobile industry, people's continuous exploitation and utilization of fossil fuel energy leads to the exhaustion of resources and degradation of the environment. This forces people to cast their eyes on electric vehicles, which are relatively environmentally-friendly. Electric vehicles' advantages lie in their use of electricity, reduced noise, renewability and non-generation of pollutants, etc. Therefore, countries all over the world have introduced policies to encourage the development of electric vehicles. However, electric vehicles still face the difficulty of travelling short distances per charge. Moreover, research shows that merely increasing the carrying capacity of the battery will cause the proportion of the car occupied by the battery to rise rapidly. As a result, the upper limit of distance per charge won't be exceeded, nor will energies will be saved. For this reason, constructing an efficient, reasonable and convenient energy replenishing network for EV charging stations is the only feasible and efficient solution.

Although many cities have started the construction of EV charging stations at present, the construction quantity and site selection scheme of such charging stations are unreasonable due to lack of corresponding construction planning theories. As a result, the following problems have arisen: (1) The quantities of users distributed to each charging station is highly uneven. Some charging stations only serve a very limited quantity of users so there is a very low utilization rate of charging station resources; in contrast, some charging stations have exceeded user capacity so that they bear tremendous service pressures and face problems like congestion or overloading the power grid; (2) It is inconvenient for users to find suitable charging stations. Because of unreasonable site selection plans, some users travel short distances to find a charging station while others must cover a long distances to find a charging station. Therefore, charging convenience is extremely poor; (3) Unreasonable construction plans waste charging station resources and thus increase construction and investment costs.

### DETAILED DESCRIPTION

### Contents of the Invention

To address the problems existing in the prior art, the present invention discloses a method to plan the optimal construction quantity and site selection scheme of EV charging stations. This effectively avoids problems arising from unreasonable schemes such as wasting resources, excessive service pressures, overlong traveling distance and high construction costs arising from unreasonable construction quantity and site selection scheme of charging stations.

The present invention adopts the following technical solution:

data preparation: investigate relevant parameters of electric vehicles of a certain city and estimate the quantity A of users that have EV charging needs in the city in one day; summarize the positions of EV parking points and divide the city into N sub-regions; calculate the probability P (N=i) of the parking points falling within the sub-region according to the frequency of such parking points in each sub-region; generate A parking points via simulation method and thus acquire the parking coordinates within the sub-regions;

(Relevant EV parameters include EV population in the region M; mean minimum tolerable electric quantity for an EV user: SOC₁; mean daily traveling mileage of EV: d; mean electricity consumption per 100 km: w)

determine the range of quantity q of charging stations to be constructed in the city, with the lower limit value q₁ of said quantity q of charging stations to be constructed being expressed as:

$${q}_{1} = ⌈ \frac{A}{{a}_{2}} ⌉$$

the upper limit value q₂ of said quantity q of charging stations to be constructed is expressed as:

$${q}_{2} = min \{ Q , ⌊ \frac{A}{{a}_{1}} ⌋ \}$$

wherein Q is the quantity of candidate charging stations to be constructed in the city; a₁ is the minimum quantity of users served by the charging station; a₂ is the maximum quantity of users served by the charging station; the operators may set the value of a₁ and a₂ on their own.

When q charging stations are selected to be constructed, each site selection plan f will constitute a station set N^{Q,q,f}, wherein, for each charging station, i∈N^{Q,q,f}, the charging station selection model is established according to the selection costs of user j to the q charging stations to be constructed around. The target charging station is selected via this selection model;

Said selection model is expressed as:

$${M}_{ij} = {ω}_{1} \frac{{l}_{ij}^{f}}{{L}^{t}} + {ω}_{2} \frac{{c}_{i} + {p}_{i}}{{c}^{f} + {p}^{f}}$$

$$Min \{ {M}_{ij} \}$$

Wherein, ω₁ and ω₂ represent the weight of traveling distance and service price, respectively, when a user chooses a charging station; lᵢⱼ^{f} represents the traveling distance for user j to station i to be constructed under site selection plan f; L^{t} is the mean tolerable traveling distance for users; c^{f} is the mean charging service price of all stations to be constructed under site selection plan f; p^{f} is the mean parking service price of all stations to be constructed under site selection plan f; cᵢ is the unit price of charging in station i; pᵢ is the unit price of parking in station i.

After user j chooses a target charging station, the constraint conditions for balance of site selection will be established and the site selection plan that satisfies the constraint condition will be reserved. Said constraint conditions for balance of site selection are expressed as:

$$\frac{1}{A} {\sum }_{i ∈ {N}^{Q} , q , f} {\sum }_{j ∈ {U}^{A}} {l}_{ij}^{f} {C}_{ij}^{f} \leq {L}^{τ}$$

$$Max \{ {l}_{if}^{f} {C}_{ij}^{f} \} \leq {L}_{max}^{t}$$

$${\sum }_{j ∈ {U}_{i}^{{A}_{f}}} {x}_{j} \leq β {A}_{i}^{f} , ∀ i ∈ {N}^{Q , q , f}$$

Wherein, cᵢⱼ^{f}={0,1}, cᵢⱼ^{f}=1 indicates that user j chooses to charge and park at the station i to be constructed under the site selection plan f, when cᵢⱼ^{f}=0, user j doesn't charge; L^{t} is the mean tolerable traveling distance of an EV user to reach a station; Lₘₐₓ^{t} is the maximum tolerable traveling distance of an EV user to reach a station; xⱼ={0,1}, xⱼ=1 indicates that the traveling distance of user j to the target charging station is longer than the mean tolerable traveling distance; xⱼ=0 indicates that the traveling distance of user j to the target charging station doesn't exceed the mean tolerable traveling distance; β indicates the balance factor for the quantity of users in each station whose traveling distance exceeds the mean tolerable traveling distance; Aᵢ^{f} is the quantity of users distributed to station i to be constructed under site selection plan f, a₁≤Aᵢ^{f}≤a₂;

in the site selection plans that satisfy the constraint conditions, choose the quantity of charging stations to be constructed with the lowest construction cost according to the target function of the charging station quantity and cost. Said target function of charging station quantity and cost is indicated as follows:

∀q∈[q₁,g₂], f∈P^{Q,q}

Min Σ_{i∈N}_{^{Q,q,f}}Dᵢ

wherein, Dᵢ indicates the construction costs of charging station i to be constructed.

Determine the optimal site selection plan for the construction quantity according to the selection of quantity of charging stations with the lowest construction costs;

$$Min ( {\sum }_{i ∈ {N}^{Q , q , f}} ( {A}_{i}^{f} - \frac{A}{q} ) + \frac{\begin{matrix}{\sum }_{i ∈ {N}^{Q , q , f}} {\sum }_{j ∈ {U}^{A}} \\ ( Max \{ {l}_{if}^{f} {C}_{ij}^{f} \} - \frac{{\sum }_{j ∈ {U}^{A}} Max \{ {l}_{if}^{f} {C}_{ij}^{f} \}}{A} )\end{matrix}}{{\sum }_{i ∈ {N}^{Q , q , f}} {\sum }_{j ∈ {U}^{A}} Max \{ {l}_{if}^{f} {C}_{ij}^{f} \}} )$$

wherein, U^{A} is the set of users with charging needs.

The beneficial effects of the present invention:

The method to plan the optimal construction quantity and site selection scheme of EV charging stations as disclosed in this invention can effectively determine the optimal construction quantity and site selection plan for EV charging stations in a certain city, guarantee that the quantity of EV users served by each charging station and the travelling distance for the users to find a charging station are in a reasonable and even level, and thus achieving the effects of effectively utilizing charging station construction resources, alleviating the service pressures on charging stations, reducing construction costs and increasing the users' efficiency to find the charging stations.

### Embodiments

To understand the technical scheme and advantages of the present invention more clearly, the present invention will be further detailed with reference to the embodiments. The embodiments described below are only provided to explain the present invention and shall not be deemed as constituting any limitation to the present invention.

Step 1, data preparation: investigate relevant parameters of EV in a city, including EV population in the region M; mean minimum tolerable electric quantity for EV users SOCₗ; EV's mean daily traveling mileage d (unit: km); EV's mean electricity consumption per 100 km (unit: kwh/100 km) and quantity of electric charge of EV in fully-charged state SOCₕ (unit: kwh);

calculate the electricity consumption of EV at mean daily traveling distance SOC_{d},

$${SOC}_{d} = \frac{d / 10 \; 0}{w} ;$$

estimate the quantity of users that have daily charging needs in the city A,

$$A = \frac{M}{( {SOC}_{h} - {SOC}_{l} ) / {SOC}_{d}} ;$$

summarize positions of EV parking points where an EV may park for over 1 h and divide the city into N sub-regions. Summarize the frequency nᵢ of parking points that satisfy the parking duration requirements within various sub-regions; calculate the probability

$$P ( N = i ) , P ( N = i ) = \frac{{n}_{i}}{{Σ}_{1}^{N} {n}_{i}}$$

of parking points falling within the sub-region; nᵢ is the frequency of parking points within sub-region i.

According to the various parameters acquired in the foregoing steps, generate A parking points within the city with the Monte Carlo simulation method; assume that the parking points within each sub-region are subjected to uniform distribution and simulate and obtain the coordinates of the parking points within the sub-region when the EV user has any charging need; all users that have charging needs shall constitute one users set U^{A}, user j∈U^{A}.

Step 2: determine the range of quantity q of charging stations to be constructed in the city; the lower limit value q₁ of said quantity q of charging stations to be constructed is indicated as:

$${q}_{1} = ⌈ \frac{A}{{a}_{2}} ⌉ ,$$

when q₁ is a decimal number, it shall be rounded up to an integer;

The upper limit value q₂ of said quantity q of charging stations to be constructed is indicated as:

$${q}_{2} = min \{ Q , ⌊ \frac{A}{{a}_{1}} ⌋ \} ,$$

when q₂ is a decimal number, it shall be rounded down to an integer;

Therefore, the range of quantity q of charging stations to be constructed in the city is indicated as:

$${q}_{1} \leq q \leq {q}_{2} , i . e . ⌈ \frac{A}{{a}_{2}} ⌉ \leq q \leq min \{ Q , ⌊ \frac{A}{{a}_{1}} ⌋ \}$$

Wherein, Q is the quantity of candidate charging stations to be constructed in the city; a₁ is the minimum quantity of users served by the charging station; a₂ is the maximum quantity of users served by the charging station; operators may set the value of a₁ and a₂ on their own.

Among the Q candidate stations known, choose q stations to be constructed which constitute one full set of site selection plan f∈P^{Q,q} and the capacity of this set is easily obtained by |P^{Q,q}|=C_{Q}^{q}; define the various stations to be constructed under any site selection plan f in set P^{Q,q} as one station set N^{Q,q,f}, station to be constructed i∈N^{Q,q,f}.

Step 3: the user charging station selection model is established according to the selection costs of user j to station i to be constructed with an amount of q charging stations around. The target charging station is selected via this selection model. According to the user charging station selection mode, distribute the A users who have charging needs to q stations to be constructed; the users arriving at the station shall constitute the set of users arriving at the station of the station Uᵢ^{A,f}.

Said selection model is indicated as:

$$∀ q ϵ [ {q}_{1} , {q}_{2} ] , f ∈ {P}^{Q . q} , i ∈ {N}^{Q , q , f} , j ∈ {U}^{A}$$

$${M}_{ij} = {ω}_{1} \frac{{l}_{if}^{f}}{{L}^{t}} + {ω}_{2} \frac{{c}_{1} + {p}_{i}}{{c}^{f} + {p}^{f}}$$

$$Min \{ {M}_{ij} \} , i ∈ {N}^{Q , q , f} , j ∈ {U}^{A}$$

Wherein, ω₁ and ω₂ represent weights for traveling distance and service price, respectively, when a user chooses a charging station; lᵢⱼ^{f} represents the traveling distance of user j to station i to be constructed under site selection plan f; L^{t} is the mean tolerable traveling distance of the user; c^{f} is the mean charging service price of all stations to be constructed under site selection plan f; p^{f} is the mean parking service price of all stations to be constructed under site selection plan f; cᵢ is the unit charging price of station i; pᵢ is the unit parking price of station i.

Step 4: After user j chooses his/her own target charging station according to the user charging station selection model, the user will start the process to find the station, i.e. the station finding process during which the user drives the EV to the target station for charging. This invention considers the constraint on the convenience of all users and a single user in searching for the station and the constraint on the balance among various stations in search; establishes constraint conditions of charging station searching; reserves the site selection plan that satisfies the constraint conditions; said constraint conditions for searching convenience and searching balance are indicated as follows:

$$∀ q ϵ [ {q}_{1} , {q}_{2} ] , f ∈ {P}^{Q , q} , i ∈ {N}^{Q , q , f} , j ∈ {U}^{A}$$

$$\frac{1}{A} {\sum }_{i ∈ {N}^{Q , q , f}} {\sum }_{j ∈ {U}^{A}} {l}_{ij}^{f} {C}_{ij}^{f} \leq {L}^{t}$$

$$Max \{ {l}_{ij}^{f} {C}_{ij}^{f} \} \leq {L}_{max}^{t}$$

$${\sum }_{j ∈ {U}^{A , f}} {x}_{j} \leq β {A}_{i}^{f} , ∀ i ∈ {N}^{Q , q , f} ,$$

Wherein, cᵢⱼ^{f}={0,1}, Cᵢⱼ^{f}=1 indicates user j chooses to head to station i to be constructed for charging and parking under site selection plan f, when cᵢⱼ^{f}=0, user j doesn't charge; L^{t} is the mean tolerable traveling distance of EV users; Lₘₐₓ^{t} is the maximum tolerable traveling distance of EV users; xⱼ={0,1}, xⱼ=1 indicates that the traveling distance of user j to the target charging station is longer than the mean tolerable traveling distance; xⱼ=0 indicates that the traveling distance of user j to the target charging station doesn't exceed the mean tolerable traveling distance; β indicates the balance factor for the quantity of users in each station whose traveling distance to various stations exceeds the mean tolerable traveling distance; Aᵢ^{f} is the quantity of users distributed to station i to be constructed under site selection plan f, a₁≤Aᵢ^{f}≤a₂;

In this embodiment, the traveling distance lᵢⱼ^{f} for each user j to reach the target station can be calculated according to the user coordinate and the station coordinate, Euclidean distance. The actual traveling distance within a city may also be adopted, i.e. generate the traveling route via Gaode Map or other navigation software intelligently, so as to determine the traveling distance.

Delete site selection plans that don't satisfy the constraint conditions and reserve site selection plans that satisfy the constraint conditions among all the site selection plans f in site selection plan set P^{Q,q} via the foregoing constraint conditions on traveling distance and traveling balance.

Repeat steps 3-4, traverse the construction quantity of all charging stations within the range of construction quantity of charging stations q₁≤q≤q₂, i.e. q=q₁, q₁+1, q₁°2, . . . , q₂, distribute users for all site selection plans in the site selection plan set and delete the unsatisfactory plans according to the constraint conditions on traveling balance. Finally, the site selection plans that satisfy the various constraint conditions for different construction quantities of charging stations are left.

In the site selection plans that satisfy the constraint conditions, choose the construction quantity of charging stations with the lowest construction cost according to the target function of charging station construction quantity and cost. Said target function of charging station construction quantity and cost is indicated as follows:

∀q∈[q₁,q₂], f∈P^{Q,q}

Min Σ_{i∈N}_{^{Q,q,f}}Dᵢ.

Step 5: based on the construction quantity of charging stations selected at step 4 and the various site selection plans that satisfy the constraint conditions for the corresponding quantity of stations to be constructed, choose the construction quantity of charging stations with the lowest construction cost according to the target function of charging station construction quantity and cost and finally determine the optimal site selection plan for the construction quantity;

in the given q, ∀i∈N^{Q,q,f}, f∈P^{Q,q} and the foregoing four constraint conditions are satisfied, j∈U^{A},

$$Min ( \begin{matrix}\frac{{\sum }_{i ∈ {N}^{Q , Q , f}} ( {A}_{i}^{f} - \frac{A}{q} )}{A} + \\ \frac{{\sum }_{i ∈ {N}^{Q , q , f}} {\sum }_{j ∈ {U}^{A}} ( Max \{ {l}_{ij}^{f} {C}_{ij}^{f} \} - \frac{{\sum }_{j ∈ {U}^{A}} Max \{ {l}_{ij}^{f} {C}_{ij}^{f} \}}{A} )}{{\sum }_{i ∈ {N}^{Q , q , f}} {\sum }_{j ∈ {U}^{A}} Max \{ {l}_{ij}^{f} {C}_{ij}^{f} \}}\end{matrix} )$$

Wherein,

$${\sum }_{i ∈ {N}^{Q , q , f}} ( {A}_{i}^{f} - \frac{A}{q} ) \text{:}$$

means the sum of differences between the quantity of users of various stations and the mean quantity of users of stations, as divided by the quantity A of users that have charging needs for normalization. The smaller the first item is, the more evenly the users are distributed to various stations;

$$\frac{{\sum }_{i ∈ {N}^{Q , q , f}} {\sum }_{j ∈ {U}^{A}} ( Max \{ {l}_{ij}^{f} {C}_{ij}^{f} \} - \frac{{\sum }_{j ∈ {U}^{A}} Max \{ {l}_{ij}^{f} {C}_{ij}^{f} \}}{A} )}{{\sum }_{i ∈ {N}^{Q , q , f}} {\sum }_{j ∈ {U}^{A}} Max \{ {l}_{ij}^{f} {C}_{ij}^{f} \}}$$

means the sum of differences between the traveling distances of various users and the actual mean traveling distance of all users, as divided by the total traveling distance Σ_{i∈N}_{^{Q,q,f}}Σ_{j∈U}_{^{A}} Max{lᵢⱼ^{f}Cᵢⱼ^{f}} of all users for normalization. The smaller the second item is, the more even the traveling distance of various users will be. Finally, the minimum value of the sum of the foregoing two items is taken as the target function and choose the site selection plan f∈P^{Q,q} that minimizes the target function value in the construction quantity q of charging stations as the optimal site selection plan for the charging stations to be constructed in the city.

The embodiments described above are merely used for explaining design thoughts and features of the present invention, the purpose of which is to enable those skilled in the art to understand the technical content of the present invention and thereby implement the present invention, the protection scope of the present invention is not limited to the embodiments described above. Therefore, any equivalent variations or modifications made on the basis of the principle and design idea disclosed in the present invention shall be deemed as falling into the protection scope of the present invention.

What is claimed is:

1. A method to plan the optimal construction quantity and site selection scheme of EV charging stations, comprising:
determining relevant parameters of electric vehicles of a certain city and estimate quantity A of users that have EV charging needs in the city;
summarizing the positions of EV parking points and divide the city into N sub-regions;
calculating the probability P(N=i) of the parking points falling within the sub-region according to the frequency of the parking points within various sub-regions;
generating A parking points with a simulation method and thus acquiring the parking coordinates within the sub-regions;
determining the lower limit value q₁ and upper limit value q₂ of quantity q of charging stations to be constructed in the city, and thus determining the range of quantity q of charging stations to be constructed;
selecting q charging stations for construction, wherein each site selection plan f constitutes a station set N^{Q,q,f}, wherein for each charging station i∈N^{Q,q,f}, the user charging station selection model is established according to the selection costs of user j to the q stations to be constructed around;
selecting the target charging station via the selection model;
after receiving a user j choice of the target charging station, establishing the constraint condition on balance of traveling distance and the site selection plan that satisfies the constraint condition will be reserved;
in the reserved site selection plan, choosing the construction quantity of charging stations with the lowest construction cost according to the target function of charging station construction quantity and cost; and
determining the optimal site selection plan for the construction quantity according to the construction quantity of charging stations with the lowest construction costs.

2. The method to plan the optimal construction quantity and site selection scheme of EV charging stations of claim 1, wherein said lower limit value
$${q}_{1} = ⌈ \frac{A}{{a}_{2}} ⌉ ,$$
said upper limit value
$${q}_{2} = min \{ Q ⌊ \frac{A}{{a}_{1}} ⌋ \} ,$$
wherein, Q is the quantity of candidate charging stations to be constructed in the city, and further wherein:
a₁ is the minimum quantity of users served by charging stations; and
a₂ is the maximum quantity of users served by charging stations.

3. The method to plan the optimal construction quantity and site selection scheme of EV charging stations of claim 1, wherein said selection model My is indicated as:
$${M}_{ij} = {ω}_{1} \frac{{l}_{ij}^{f}}{{L}^{t}} + {ω}_{2} \frac{{c}_{i} + {p}_{i}}{{c}^{f} + {p}^{f}}$$
$$Min \{ {M}_{ij} \}$$
wherein, ω₁ and ω₂ represent the weight of traveling distance and service price when a user chooses a charging station;
lᵢⱼ^{f} represents the traveling distance for user j to station i to be constructed under site selection plan f;
L^{t} is the mean tolerable traveling distance of users;
c^{f} is the mean charging service price of all stations to be constructed under site selection plan f;
p^{f} is the mean parking service price of all stations to be constructed under site selection plan f;
cᵢ is the unit charging price of station i; and
pᵢ is the unit parking price of station i.

4. The method to plan the optimal construction quantity and site selection scheme of EV charging stations of claim 3, wherein said constraint conditions for traveling balance are indicated as:
$$\frac{1}{A} {\sum }_{i ∈ {N}^{Q , q , f}} {\sum }_{j ∈ {U}^{A}} {l}_{ij}^{f} {C}_{ij}^{f} \leq {L}^{t}$$
$$Max \{ {l}_{ij}^{f} {C}_{ij}^{f} \} \leq {L}_{max}^{t}$$
$${\sum }_{j ∈ {U}^{A , f}} {x}_{j} \leq β {A}_{i}^{f} , ∀ i ∈ {N}^{Q , q , f} ,$$
wherein Cᵢⱼ^{f}={0,1}, Cᵢⱼ^{f}=1 indicates user j chooses to head to station i to be constructed for charging and parking under the site selection plan f, when Cᵢⱼ^{f}=0, user j doesn't charge;
Lₘₐₓ^{t} is the maximum tolerable traveling distance of EV users; xⱼ={0,1}, xⱼ=1 indicates that the traveling distance of user j to the target charging station is longer than the mean tolerable traveling distance xⱼ=0 indicates that the traveling distance of user j to the target charging station doesn't exceed the mean tolerable traveling distance;
β indicates the balance factor for the quantity of users in each station whose traveling distance to various stations exceed the mean tolerable traveling distance;
Aᵢ^{f} is the quantity of users distributed to station i to be constructed under site selection plan f, a₁≤Aᵢ^{f}≤a₂.

5. The method to plan the optimal construction quantity and site selection scheme of EV charging stations of claim 1, wherein said constraint conditions for traveling balance are indicated as:
$$\frac{1}{A} {\sum }_{i ∈ {N}^{Q , q , f}} {\sum }_{j ∈ {U}^{A}} {l}_{ij}^{f} {C}_{ij}^{f} \leq {L}^{t}$$
$$Max \{ {l}_{ij}^{f} {C}_{ij}^{f} \} \leq {L}_{max}^{t}$$
$${\sum }_{j ∈ {U}^{A , f}} {x}_{j} \leq β {A}_{i}^{f} , ∀ i ∈ {N}^{Q , q , f} ,$$
wherein cᵢⱼ^{f}={0,1}, cᵢⱼ^{f}=1 indicates user j chooses to head to station i to be constructed for charging and parking under the site selection plan f, when Cᵢⱼ^{f}=0, user j doesn't charge;
Lₘₐₓ^{t} is the maximum tolerable traveling distance of EV users; xⱼ={0,1}, xⱼ=1 indicates that the traveling distance of user j to the target charging station is longer than the mean tolerable traveling distance xⱼ=0 indicates that the traveling distance of user j to the target charging station doesn't exceed the mean tolerable traveling distance;
β indicates the balance factor for the quantity of users in each station whose traveling distance to various stations exceed the mean tolerable traveling distance;
Aᵢ^{f} is the quantity of users distributed to station i to be constructed under site selection plan f, a₁≤Aᵢ^{f}≤a₂.

6. The method to plan the optimal construction quantity and site selection scheme of EV charging stations of claim 1, wherein a target function of the charging station construction quantity and cost is indicated as:
∀q∈[q₁,q₂], f∈P^{Q,q}
Min Σ_{i∈N}_{^{Q,q,f}}Dᵢ
wherein Dᵢ indicates the construction costs of charging station i to be constructed.

7. The method to plan the optimal construction quantity and site selection scheme of EV charging stations of claim 1, wherein the method to determine the optimal site selection plan is indicated as:
$$Min ( \frac{{\sum }_{i ∈ {N}^{Q , q , f}} ( {A}_{i}^{f} - \frac{A}{q} )}{A} + \frac{{\sum }_{i ∈ {N}^{Q , q , f}} {\sum }_{j ∈ {U}^{A}} ( Max \{ {l}_{ij}^{f} {C}_{ij}^{f} \} - \frac{{\sum }_{j ∈ {U}^{A}} Max \{ {l}_{ij}^{f} {C}_{ij}^{f} \}}{A} )}{{\sum }_{i ∈ {N}^{Q , q , f}} {\sum }_{j ∈ {U}^{A}} Max \{ {l}_{ij}^{f} {C}_{ij}^{f} \}} )$$
wherein U^{A} is the set of users with charging needs.
